(19) United States
(12) Patent Application Publication
(10) Pub. No.: US 2017/0130697 A1
(43) Pub. Date: May 11, 2017

(54) WIND TURBINE DEVICE HAVING A FLOW GUIDE CASING

(71) Applicant: Kuo-Chang HUANG, Tainan City (TW)

(72) Inventor: Kuo-Chang HUANG, Tainan City (TW)

(21) Appl. No.: 15/297,445

(22) Filed: Oct. 19, 2016

(30) Foreign Application Priority Data
Nov. 5, 2015 (TW) 104136428

(51) Int. Cl. F03D 3/04; F03D 3/06; F03D 3/00

(52) U.S. Cl. CPC F03D 3/0454; F03D 3/005; F03D 3/065

(57) ABSTRACT

A wind turbine device includes a rotary unit and a flow guide casing. The rotary unit includes a rotary shaft and a plurality of blades connected to and extending axially along the rotary shaft. The flow guide casing borders a blade rotating space at a downwind side of the rotary unit to allow rotation of the blades and includes an external flow pas sage that is disposed around the blade rotating space and that has an inlet and an outlet. The external flow passage is able to guide an assisting wind current to enter the inlet and to thereafter flow into the blade rotating space through the outlet for propelling the blades at the downwind side.

### CROSS-REFERENCE TO RELATED APPLICATION

This application claims priority of Taiwanese Application No. 104136428, filed on Nov. 5, 2015.

### FIELD

The disclosure relates to a wind turbine device, and more particularly to a wind turbine device having a flow guide casing.

### BACKGROUND

Referring to FIG. 1, a conventional wind turbine device is driven by wind blowing in a direction (F0), and includes a rotary unit 9 and a cover 8. The rotary unit 9 includes a rotary shaft 91 and a plurality of angularly spaced-apart blades 92 connected to the rotary shaft 91. The blades 92 drive the rotary shaft 91 to rotate in an operation direction (T0) when propelled by the wind. The cover 8 is disposed at one side of a plane (S0) that extends parallel to and through the rotary shaft 91. The cover 8 borders a rotary space 80 that receives and allows the blades 92 to rotate in the operation direction (T0). The cover 8 is used to shield the blades 92 in the rotary space 80 from being propelled by the wind. That is, the blades 92 in the rotary space 80 will not rotate the rotary shaft 91 in a reverse direction against the operation direction (T0).

However, the conventional wind turbine device cannot provide additional enhancement of rotating torque.

### SUMMARY

Therefore, an object of the disclosure is to provide a wind turbine device that can enhance rotation torque.

According to the disclosure, a wind turbine device includes a rotary unit and a flow guide casing.

The rotary unit includes a rotary shaft, a plurality of angularly spaced-apart blades connected to and extending axially along the rotary shaft, and upwind and downwind sides which are defined respectively on two opposite sides of a plane that extends parallel to and through the rotary shaft. The blades are capable of rotating and passing alternately through the upwind and downwind sides to drive the rotary shaft to rotate in an operation direction when being propelled by wind.

The flow guide casing is disposed at the downwind side and borders a blade rotating space that allows the blades to rotate in the operating direction at the downwind side. The blade rotating space has first and second end portions opposite to each other along a circumferential direction with respect to the rotary shaft. The flow guide casing includes an external flow passage that is disposed around the blade rotating space and that has an inlet disposed proximally to and disconnected from the first end portion of the blade rotating space, and an outlet disposed proximally to and communicating with the second end portion of the blade rotating space. The external flow passage is able to guide an assisting wind current to enter the inlet and to thereafter flow into the blade rotating space through the outlet for propelling the blades in the operation direction at the downwind side.

### BRIEF DESCRIPTION OF THE DRAWINGS

Other features and advantages of the disclosure will become apparent in the following detailed description of the embodiments with reference to the accompanying drawings, of which:

FIG. 1 is a sectional view of a conventional wind turbine device;

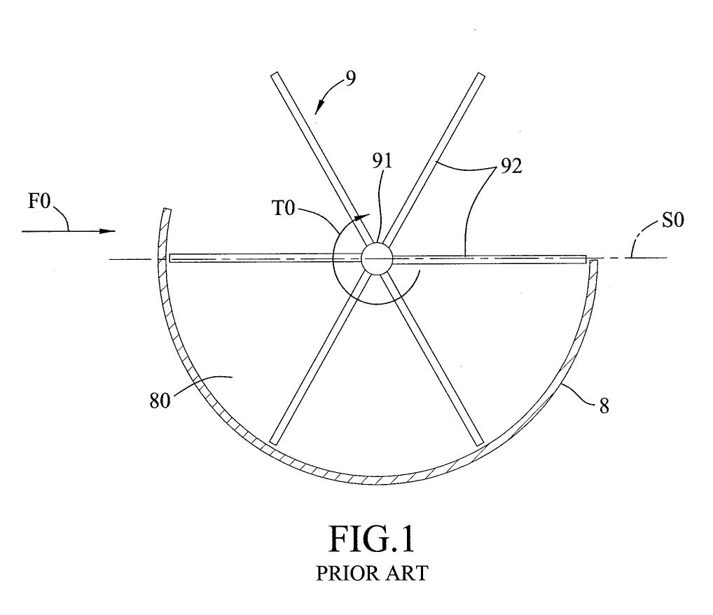

FIG. 2 is a partly exploded perspective view of a wind turbine device according to a first embodiment of the present disclosure;

FIG. 3 is a sectional view of the first embodiment;

FIG. 4 is a partly exploded perspective view of a wind turbine device according to a second embodiment of the present disclosure; and

FIG. 5 is a sectional view of the second embodiment.

### DETAILED DESCRIPTION

Before the disclosure is described in greater detail, it should be noted that like elements are denoted by the same reference numerals throughout the disclosure.

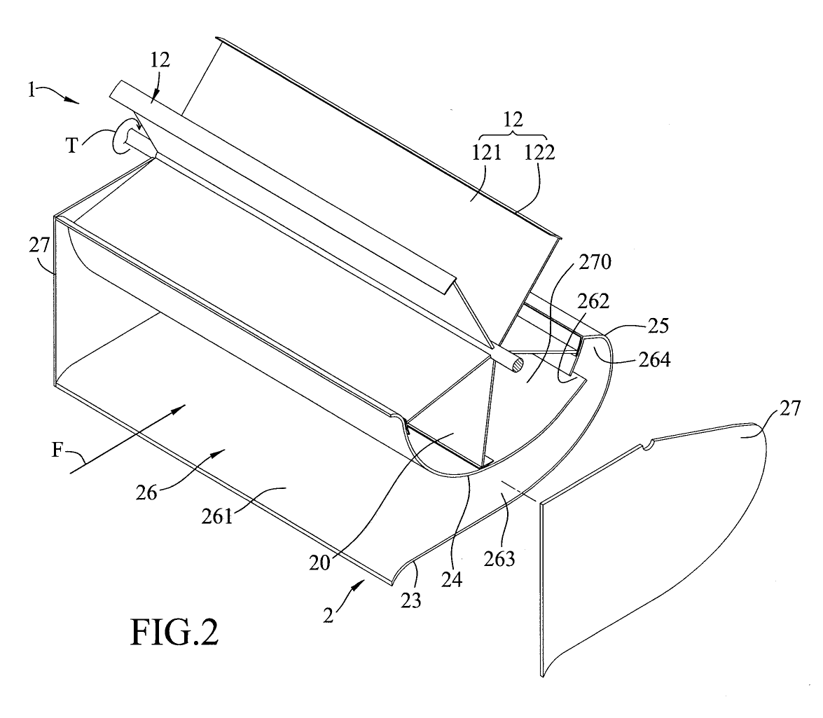

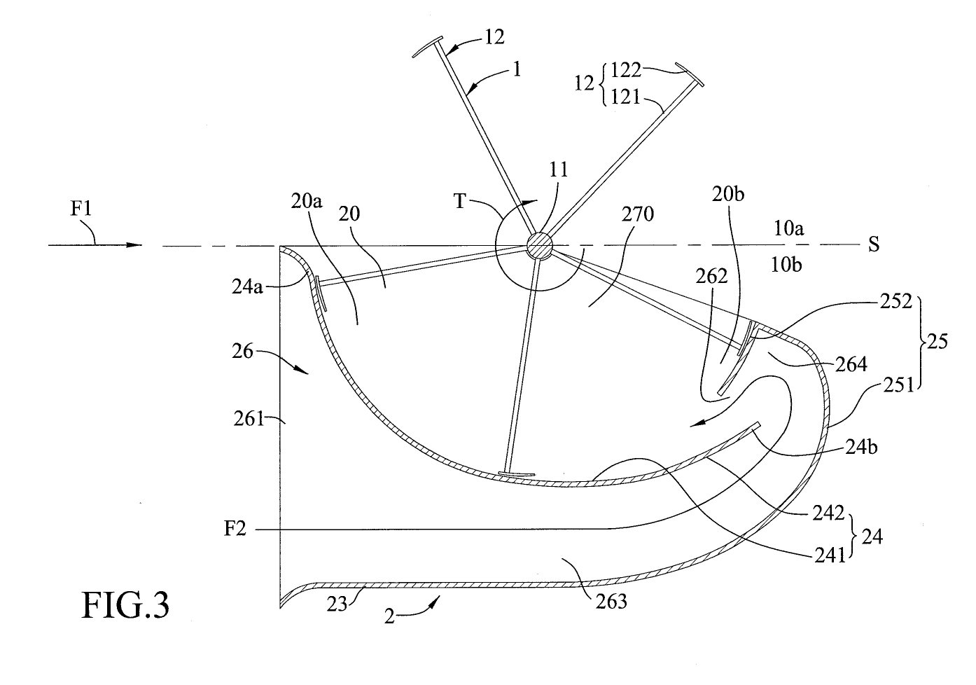

Referring to FIGS. 2 and 3, a wind turbine device according to a first embodiment of the present disclosure includes a rotary unit 1 and a flow guide casing 2.

In this embodiment, the rotary unit 1 includes a rotary shaft 11, five angularly spaced-apart blades 12 connected to and extending axially along the rotary shaft 11, and upwind and downwind sides (10a, 10b) which are defined respectively on two opposite sides of a plane (S) that extends parallel to and through the rotary shaft 11. The rotary shaft 11 extends horizontally and is elevated by a support frame (not shown). The blades 12 are capable of rotating and passing alternately through the upwind and downwind sides (10a, 10b) for driving the rotary shaft 11 to rotate in an operation direction (T) when being propelled by wind blowing in a direction (F1). Each blade 12 includes a blade plate 121 connected to the rotary shaft 11, and a tail endplate 122 connected to an outer end of the blade plate 121 opposite to the rotary shaft 11. The tail endplate 122 extends arcuately from the blade plate 121 in a direction opposite to the operation direction (T). When the blade plate 121 is propelled by the wind, the tail end plate 122 functions to stabilize the movement of the blade plate 121 along the operation direction (T).

The flow guide casing 2 is disposed at the downwind side (10b). The upwind side (10a) is at the upper side of the plane (S), where the operation direction (T) of the blades 12 and the rotary shaft 11 is similar to the direction (F1) of the wind. The downwind side (10b) is at the lower side of the plane (S), where the operation direction (T) is opposite to the direction (F1) of the wind.

Referring back to FIG. 3, the blades 12 at the upwind side (10a) above the plane (S) are driven by the wind blowing in the direction (F1) to rotate in the operation direction (T). The blades 12 at the downwind side (10b) below the plane (S) are shielded by the flow guide casing 2 from being propelled by the wind blowing in the direction (F1). Alternatively, the flow guide casing 2 may be disposed at the upper side of the plane (S). In this case, the upwind side of the rotary unit 1 is below the plane (S).

The flow guide casing 2 borders a blade rotating space 20 to allow the blades 12 to rotate in the operating direction (T) at the downwind side (10b). The blade rotating space 20 has first and second end portions (20a, 20b) opposite to each other along a circumferential direction with respect to the rotary shaft 11. Particularly, the flow guide casing 2 subtends an included angle at the center of the rotary shaft 11, which is greater than an included angle formed between two adjacent ones of the blades 12. For example, when the included angle formed between two adjacent ones of the blades 12 is 72°, the included angle of the flow guide casing 2 is 160°.

Further, the flow guide casing 2 includes an external flow passage 26 that is disposed around the blade rotating space 20. The external flow passage 26 has an inlet 261 disposed proximally to and disconnected from the first end portion (20a) of the blade rotating space 20, and an outlet 262 disposed proximally to and communicating with the second end portion (20b) of the blade rotating space 20. The external flow passage 26 is able to guide an assisting wind current (F2) to enter the inlet 261 and to thereafter flow into the blade rotating space 20 through the outlet 262 for propelling the blades 12 in the operation direction (T) at the downwind side (10b). Specifically, the external flow passage 26 further has a guiding section 263 connected to and arcuately extending away from the inlet 261, and a turning section 264 that is connected between the guiding section 263 and the outlet 262 and that turns in a reverse direction opposite to a forward direction from the inlet 261 to the guiding section 263. The guiding section 263 is gradually widened from the turning section 264 to the inlet 261. The external flow passage 26 guides the assisting wind current (F2) to enter the guiding section 263 from the inlet 261 and to exit the outlet 262 through the turning section 264.

In this embodiment, the flow guide casing 2 further includes two end covers 27, an inner casing wall 24, an outer casing wall 23 and an extension guiding wall 25.

The end covers 27 are axially spaced apart from each other. An axial distance between the end covers 27 is slightly greater than an axial length of each blade 12. The end covers 27 bound both of the blade rotating space 20 and the external flow guide passage 26. The blade rotating space 20 forms an enclosed space 270 that is bounded by the end covers 27 and two of the blades 12. The enclosed space 270 communicates only with the outlet 262.

The inner casing wall 24 is connected between the end covers 27 to border the blade rotating space 20, and has a width approximately equal to the axial length of each blade 12. In this embodiment, the inner casing wall 24 has an inner surface 241 facing the blade rotating space 20, and an outer surface 242 opposite to the inner surface 241 and facing the outer casing wall 23. A distance between the inner surface 241 and the rotary shaft 11 is slightly greater than a radial length of each blade 12 such that each blade 12 is in sliding contact with the inner surface 241 when rotating in the blade rotating space 20.

The outer casing wall 23 is disposed around the inner casing wall 24 and connected between the end covers 27, and has a width approximately equal to the axial length of each blade 12. The outer and inner casing walls 23, 24 cooperatively define the guiding section 263 and the inlet 261. In this embodiment, the inner casing wall 24 has an upstream end (24a) adjacent to the inlet 261, and a downstream end (24b) opposite to the upstream end (24a) and adjacent to the second end portion (20b) of the blade rotating space 20. Specifically, the inner casing wall 24 has a curvature greater than that of the outer casing wall 23 so that a distance between the inner and outer casing walls 23, 24 increases from the guiding section 263 toward the inlet 261.

The extension guiding wall 25 is disposed away from the inlet 261, and extends arcuately and inwardly from the outer casing wall 23 toward the rotary shaft 11. The extension guiding wall 25 bends around the downstream end (24b) of the inner casing wall 24 in a spaced apart fashion, and cooperates with the downstream end (24b) to define the turning section 264 and the outlet 262. The turning section 264 turns around the downstream end (24b) to extend in the reverse direction. In this embodiment, the extension guiding wall 25 has a bent portion 251 bending about the downstream end (24b) and extending from the outer casing wall 23 to a location that is more proximal to the rotary shaft 11 than the downstream end (24b), and an end portion 252 bending from the bent portion 251 into the blade rotating space 20. The end portion 252 and the downstream end (24b) of the inner casing wall 24 cooperatively defining the outlet 262. A distance between the end portion 252 and the rotary shaft 11 is slightly greater than the radial length of each blade 12 so that each blade 12 is in sliding contact with the end portion 252 when rotating in the blade rotating space 20 and moving past the end portion 252. As shown in FIG. 3, during operation of the wind turbine device of the present disclosure, one of the blades 12 in the blade rotating space 20 is in sliding contact with the end portion 252 while the other blades 12 are in sliding contact with the inner surface 241.

When the blades 12 outside the blade rotating space 20 are propelled by the wind blowing in the direction (F1) to rotate the rotary shaft 11 in the operation direction (T), because the inner casing wall 24 shields the blades 12 in the blade rotating space 20, the wind blowing in the direction (F1) will not act on the blades 12 in the blade rotating space 20. Therefore, wind resistance may be avoided at the downwind side (10b).

On the other hand, because the inlet 261 has a funnel-shaped opening, a considerable amount of wind energy may be guided into the inlet 261, thereby achieving a wind collecting effect. When the external flow passage 26 guides the assisting wind current (F2) to enter the guiding section 263 from the inlet 261, the assisting wind current (F2) is turned reversely by the turning section 264 to exit the outlet 262 and enter the blade rotating space 20, thereby enabling the assisting wind current (F2) to rotate the blades 12 in the blade rotating space 20 along the operation direction (T). Because the assisting wind current (F2) is applied to the blades 12 at the downwind side (10b) through the external flow passage 26, in addition to the wind blowing in the direction (F1) at the upwind side 10a, a rotating torque of the rotary shaft 11 is increased.

Referring back to FIG. 3, because the enclosed space 270 is formed between one of the blades 12 which is in sliding contact with the inner surface 241 of the inner casing wall 24 and the other one of the blades 12 which is in sliding contact with the end portion 252 of the extension guiding wall 25, the wind energy collected by the external flow passage 26 may be effectively trapped within the enclosed space 270 to operate the blades 12. Accordingly, the rotating torque of the rotary shaft 11 can be increased.

As described hereinbefore, the included angle of the flow guide casing 2 is larger than that formed between two adjacent ones of the blades 12 in this embodiment. However, if the included angle of the flow guide casing 2 is smaller than that formed between two adjacent ones of the blades 12, the flow guide casing 2 still can provide an assisting wind force to increase the rotating torque of the rotary unit 2. Further, the end covers 27 may be arranged to not cover or bound the blade rotating space 20.

Because the wind direction varies, a rudder plate (not shown) may be used to adjust the wind turbine device of the present disclosure to a position that can face toward the wind.

The flow guide casing 2 may or may not extend to the upwind side (10a) of the rotary unit 1 as long as it can cover the downwind side (10b) to prevent the blades 12 operating at the downwind side (10b) from being acted directly by the wind blowing in the direction (F1) at the upwind side (10a).

While the rotary shaft 11 of the wind turbine device of this embodiment is horizontal, the rotary shaft 11 may be arranged vertically to serve as a vertical axis wind turbine device.

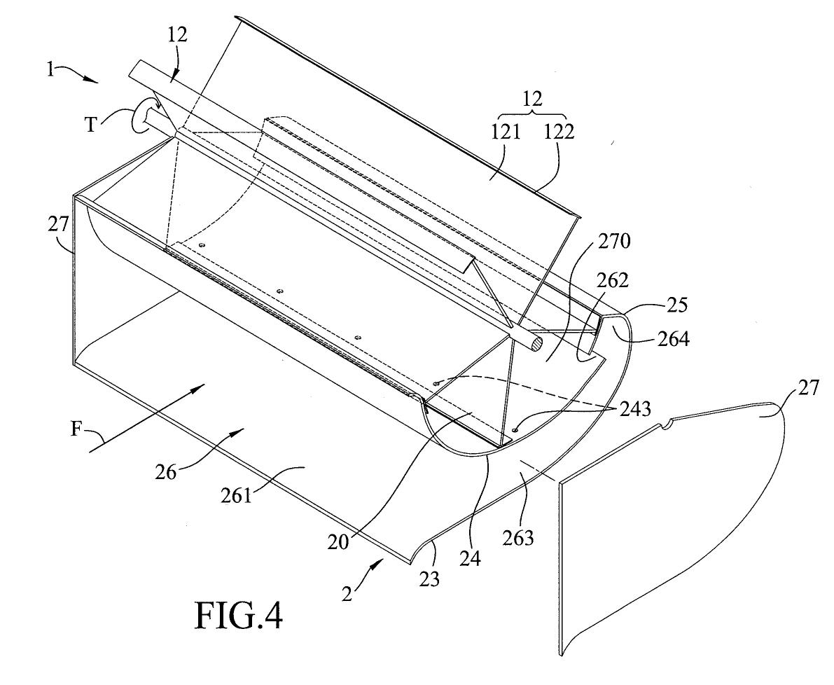

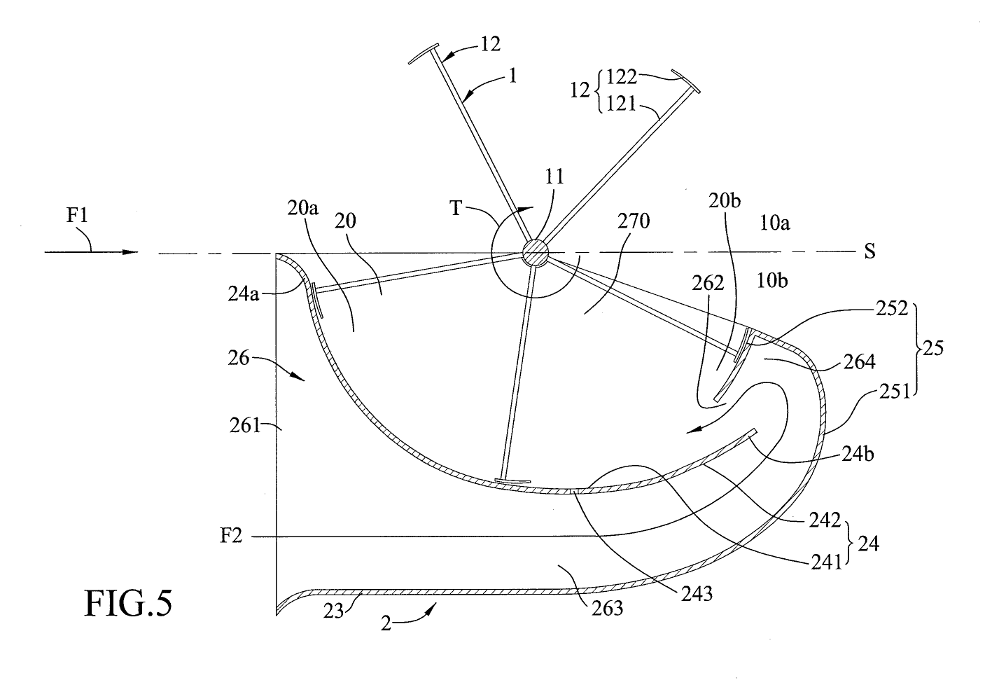

Referring to FIGS. 4 and 5, a wind turbine device according to a second embodiment of the present disclosure is substantially and structurally similar to that of the first embodiment. The difference of the second embodiment is that the inner casing wall 24 has a plurality of through holes 243 formed in a relatively low area between the upstream (24a) and the downstream (24b) of the inner casing wall 24. The through holes 243 communicate the blade rotating space 20 and the external flow passage 26. When raining, the rain accumulated in the blade rotating space 20 can drain into the external flow passage 26 through the through holes 243, and flow off the external flow passage 26 through the inlet 261.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A wind turbine device comprising:
a rotary unit including a rotary shaft, a plurality of angularly spaced-apart blades connected to and extending axially along said rotary shaft, and upwind and downwind sides which are defined respectively on two opposite sides of a plane that extends parallel to and through said rotary shaft, said blades being capable of rotating and passing alternately through said upwind and downwind sides for driving said rotary shaft to rotate in an operation direction when being propelled by wind; and
a flow guide casing disposed at said downwind side and bordering a blade rotating space that allows said blades to rotate in the operating direction at said downwind side, said blade rotating space having first and second end portions opposite to each other along a circumferential direction with respect to said rotary shaft, said flow guide casing including an external flow passage that is disposed around said blade rotating space and that has an inlet disposed proximally to and disconnected from said first end portion of said blade rotating space, and an outlet disposed proximally to and communicating with said second end portion of said blade rotating space;
wherein said external flow passage is able to guide an assisting wind current to enter said inlet and to thereafter flow into said blade rotating space through said outlet for propelling said blades in the operation direction at said downwind side.

2. The wind turbine device as claimed in claim 1, wherein said external flow passage further has a guiding section connected to and arcuately extending away from said inlet, and a turning section that is connected between said guiding section and said outlet and that turns in a reverse direction opposite to a forward direction from said inlet to said guiding section, said external flow passage guiding the assisting wind current to enter said guiding section from said inlet and to exit said outlet through said turning section.

3. The wind turbine device as claimed in claim 2, wherein said guiding section is gradually widened from said turning section to said inlet.

4. The wind turbine device as claimed in claim 2, wherein said flow guide casing further includes two end covers axially spaced apart from each other and bounding said blade rotating space and said external flow guide passage, said blade rotating space forming an enclosed space that is bounded by said end covers and two of said blades, and that communicates with said outlet.

5. The wind turbine device as claimed in claim 4, wherein said flow guide casing further includes an inner casing wall connected between said end covers to border said blade rotating space, and an outer casing wall that is disposed around said inner casing wall and connected between said end covers, said outer and inner casing walls cooperatively defining said guiding section and said inlet.

6. The wind turbine device as claimed in claim 5, wherein said inner casing wall has an inner surface facing said blade rotating space, and an outer surface opposite to said inner surface and facing said outer casing, each of said blades being in sliding contact with said inner surface when rotating in said blade rotating space.

7. The wind turbine device as claimed in claim 5, wherein said inner casing wall has an upstream end adjacent to said inlet, and a downstream end opposite to said upstream end and adjacent to said second end portion of said blade rotating space, said flow guide casing further including an extension guiding wall that is disposed away from said inlet, and that extends arcuately and inwardly from said outer casing wall toward said rotary shaft, said extension guiding wall bending around said downstream end in a spaced apart fashion and cooperating with said downstream end to define said turning section and said outlet, said turning section turning around said downstream end to extend in the reverse direction.

8. The wind turbine device as claimed in claim 1, wherein said flow guide casing subtends an included angle at the center of said rotary shaft, the included angle of said flow guide casing being greater than an included angle formed between two adjacent ones of said blades.

9. The wind turbine device as claimed in claim 1, wherein each of said blades includes a blade plate connected to said rotary shaft, and a tail end plate connected to an outer end of said blade plate opposite to said rotary shaft, said tail endplate extending arcuately from said outer end in a direction opposite to the operation direction.
